(19) United States
(12) Patent Application Publication
(10) Pub. No.: US 2008/0151088 A1
(43) Pub. Date: Jun. 26, 2008

(54) Switching Circuit Arrangement

(76) Inventors: Alexander Frey, Munchen (DE); Meinrad Schienle, Ottobrunn (DE); Roland Thewes, Grobenzell (DE)

Correspondence Address: HARNESS, DICKEY & PIERCE, P.L.C., P.O.BOX 8910, RESTON, VA, 20195, US

(21) Appl. No.: 11/596,005

(22) PCT Filed: May 12, 2005
(86) PCT No.: PCT/DE05/00876

§ 371 Date: Aug. 27, 2007

(30) Foreign Application Priority Data
May 13, 2004 (DE) 10 2004 023 855.3

(51) Int. Cl. H04N 5/335; H04N 3/14

(52) U.S. Cl. 348/308; 348/E05.091

(57) ABSTRACT

A switching circuit arrangement is disclosed. The arrangement includes a substrate, a plurality of functional units arranged on the substrate, a plurality of selection line groups including selection lines, a plurality of signal line groups including signal lines, a buffer unit for each signal line group, a selection unit which is coupled to the selection line groups, and a signal unit which is coupled to the signal lines.

### PRIORITY STATEMENT

This application is the national phase under 35 U.S.C. § 371 of PCT International Application No. PCT/DE2005/000876 which has an International filing date of May 12, 2005, which designated the United States of America and which claims priority on German Patent Application number DE 10 2004 023 855.3 filed May 13, 2004, the entire contents of which are hereby incorporated herein by reference.

### FIELD

The invention generally relates to a circuit arrangement.

### BACKGROUND

In sensor arrays, sensor elements of the same or even different type are often arranged in an array, for example in the form of a matrix. Such arrangements, unlike individual sensors, enable important additional information to be found, such as the spatial resolution of sensor events. Such arrangements also allow sensor processes to run in parallel in time.

In order to read out the signal from a sensor element in an array, the sensor element is often connected to interface circuits and devices. Often it is not possible from a technical perspective or not practical economically to connect each individual sensor element individually i.e. to wire them up to the interface circuits using lines separately allocated to each individual sensor element.

Employing a switching matrix using row lines and column lines that are selected by row and column decoders, each row line or column line being assigned to a plurality of sensor elements in common, enables one or at least a reduced number of signal lines to be shared for the output signals of the individual sensors, by which the sensor array transfers the data from the sensor elements to the interface circuits. Such a wiring architecture means that certain constraints must be observed when reading out a sensor array.

A sensor arrangement known in the prior art is described below with reference to FIG. 1A.

In the sensor arrangement 100 of FIG. 1A, a plurality of sensor elements 102 is arranged in the form of a matrix on a substrate 101. Each sensor element 102 is connected to a row line 103 and to a column line 104, a common row line 103 being provided for each of sensor elements 102 of a row, and a common column line 104 being provided for each of sensor elements 102 of a column. The row lines 103 are connected to a row decoder 105, whilst the column lines 104 are connected to a column decoder 106.

As shown in the magnified view of individual sensor elements 102 in FIG. 1A, by applying a suitable signal to the row line 103 pertaining to a specific sensor element 102, a switch element 110 of a sensor element 102 to be selected is closed, whereby the sensor field 109 (for instance a sensor electrode at which sensor events can take place) pertaining to the sensor element 102 to be selected is connected to the associated column line 104. A sensor element selected in this way can then be connected to the electronic interface circuit 107 if the selection switch 111 contained in the column decoder 106 has a suitable switch setting, whereby the sensor signal from the selected sensor element 102 is provided at an output of the electronic interface circuit. The row decoder 105 and the column decoder 106 are given the address of a sensor element 102 to be selected by an address generator 108.

The sensor arrangement 100 of FIG. 1A is a 4×4 sensor array. A sensor element 102 of the sensor arrangement 100 is selected by providing the column decoder 105 and the row decoder 106 with such control signals that a specific sensor element 102a can be selected. The sensor element 102 at the intersection of an enabled column and row is the selected sensor element 102a. To read out its sensor signal, this selected sensor element 102a is connected to the electronic interface circuit 107.

A sensor arrangement 150 according to the prior art is described below with reference to FIG. 1B, in which are shown details of the electronic interface circuit 107 of FIG. 1A.

The selection switch 111 is connected to an input of a first amplifier 151, which has a first and a second output. The first output of the first amplifier is connected to a first input of a comparator 153, whose second input is connected to a reference current source 152. The second output of the first amplifier 151 is connected to an input of a second amplifier 154. The second amplifier 154 is controlled by a control signal supplied by an output of the comparator 153. In addition, an output of the second amplifier 154 is connected to an input of an analog-to-digital converter 155, whose output, like the output of the comparator 153, is connected to an output unit 156.

The “frame frequency” is the definitive measure of the achievable temporal resolution that a sensor arrangement 100 or a sensor arrangement 150 can deliver. The frame frequency is obtained from the time required to read out the whole sensor arrangement once in full. The “pixel frequency” is the crucial factor here. It is given by the time required to read out a single sensor element 102. Thus, for the array architecture of FIG. 1A, the frame frequency is obtained from the quotient of the pixel frequency and the number of sensor elements 102 of the sensor arrangement 100.

For a constant pixel frequency, the frame frequency is inversely proportional to the number of sensor elements 102. Thus for a large sensor arrangement 100 having a large number of sensor elements 102, only a slower read-out is possible if the pixel frequency cannot be increased correspondingly.

The transient response times of a sensor element 102 and of the electronic interface circuit 107 after selecting a sensor element 102a limit the pixel frequency. These transient response times are usually inversely proportional to the size of the sensor signal, so that for small signal amplitudes the transient response times are often very long. A large dynamic range of a sensor, i.e. the range of signal amplitudes to be covered, can also result in long transient response times, in particular in the interface circuits 107, because the operating point must vary within a large range.

The interrelationships described can hence lead to an unsatisfactory read-out speed, in particular for a sensor arrangement 100 containing a large number of sensor elements 102 that are to supply a signal over a large dynamic range. This problem is further aggravated when the dynamic range is also to contain very small signal amplitudes in particular.

An electronic DNA sensor array is disclosed in [1].

A sensor arrangement is disclosed in [2], in which the sensor devices are calibrated column by column before the actual measurement. A column to be calibrated is selected by applying a control signal having the logic value “1” to a selection terminal, and a sensor device of the corresponding column is calibrated using a read-out or calibration circuit and a selector-switch element, which is switched such that a constant current is injected into the sensor device to be calibrated. In addition, to calibrate the sensor devices of a column, a control signal having the logic value “1” is briefly applied to a calibration terminal of the corresponding column. During the measurement, a column is selected by a selection terminal, and a sensor device of the corresponding column is read out using the aforementioned read-out or calibration circuit and the aforementioned selector-switch element, which is switched such that a constant voltage is applied to the sensor device to be read out.

A sensor array is described in [3], in which a plurality of sensor cells, which can be connected to row lines and column lines, are arranged on a substrate. Both the row lines and the column lines can be connected to at least two of the sensor cells in each case.

The sensor cells can be selected individually using a row-selection register and a column-selection register. In addition, the arrangement described in [3] includes a multiplexing and amplification circuit connected to the sensor cells, which is controlled by a second column-selection register. By way of the multiplexing and amplification circuit and the second column-selection register, the output signals of individual sensor cells are amplified and provided sequentially as the output signal from the sensor array.

A sensor arrangement is disclosed in [4], in which the individual sensors are provided, before the measurement, with a potential lying close to the measured value of the sensor element to be read out.

A sensor array is described in [5], in which initially the operating point of a sensor element is set via a switch during a set-up phase preceding a measurement phase, and afterwards the sensor element is read out via a different switch.

### SUMMARY

At least one embodiment of the invention is based in particular on the problem of creating a circuit arrangement in which a signal transfer between a plurality of functional units and an electronic interface circuit can take place with sufficient speed.

The problem is solved by a circuit arrangement having the features given in at least one embodiment of the invention.

The circuit arrangement according to at least one embodiment of the invention comprises a substrate, a plurality of functional units arranged on the substrate and a plurality of selection-line groups, each selection-line group having at least two selection lines, each of which can be connected to at least two of the functional units. In addition, a plurality of signal-line groups is provided, each signal-line group having at least two signal lines, each of which can be connected to at least two of the functional units. A buffer unit is provided for each signal-line group.

In addition, a selection unit connected to the selection-line groups is provided, which is configured such that by applying a selection signal to the selection lines of a selection-line group to be selected, the functional units connected to the selection lines of the selected selection-line group are connected to the associated signal lines.

The circuit arrangement also contains a signal unit connected to the signal lines, which is configured such that it selects one, and only one, of the signal-line groups at a time in such a way that, of those functional units that belong both to the selected selection-line group and to the selected signal-line group, one, and only one, functional unit is selected at a time for signal transfer between this functional unit and the signal unit. The signal unit is also configured such that, of those functional units that belong both to the selected selection-line group and to an unselected signal-line group, it connects one, and only one, functional unit at a time to the associated buffer unit, thereby allowing this functional unit to settle.

At least one embodiment of the invention is based on performing a signal transfer between a selected functional unit and a signal unit, in a circuit arrangement having a plurality of functional units, in a manner that is faster compared with the prior art, by advancing in time the transient behavior—which reduces the pixel frequency—of a respective functional unit with respect to the actual signal transfer between the functional unit and the signal unit. In other words, those functional units that are intended for signal transfer in the relatively near future, are already connected to a buffer unit during the signal transfer of other functional units, so that the functional units due for imminent signal transfer can already settle.

If the signal transfer of the functional unit that is ahead in time then finishes, and the signal transfer of the functional unit that has meanwhile already at least partially settled into a steady state, begins, then the effective signal transfer time, composed of the transient response time and actual signal transfer time, for the functional unit now undergoing a signal transfer, is reduced by the advanced (already fully or partially elapsed) transient response time.

Signals are transferred between the functional units and the signal unit. When the circuit arrangement is configured as a sensor arrangement, sensor signals from the functional units formed as sensor elements are read out to a signal processing unit for example. For a circuit arrangement configured as a display unit, the functional units implemented as display pixels are supplied by a supply unit, for example, such that the pixels are provided with the information that they require to display the pixel information. The circuit arrangement is not restricted to the two implementations as sensor arrangement or display unit described, but rather the architecture of the circuit arrangement according to at least one embodiment of the invention can be used for any arrangement having a plurality of functional units that are supplied with signals or from which signals are taken.

The circuit arrangement of at least one embodiment of the invention, in particular in its embodiment as sensor arrangement, is suitable for reading out sensor signals even of low amplitude and large dynamic range at sufficiently high speed even for sensor arrangements having a large number of sensor elements.

An important aspect of at least one embodiment of the invention is that transient response times of functional units in a data path of a circuit arrangement having a plurality of functional units, in particular sensor elements of a sensor arrangement, are ostensibly concealed by means of a suitable array architecture, and hence the potential read-out speed of the sensor array is increased. A sensor element for later read-out is already selected in advance, so that up to the time at which its read-out starts, it can go through, and preferably also complete by the start of its read-out, its transient behavior.

The read-out time of a sensor element is then only given by the actual data transfer time, whilst the transient response time shifted in advance of the data transfer is eliminated. In other words, the functional units are brought into a steady state in a process step advanced with respect to the actual read-out, from which state the actual read-out can then proceed without delay.

A fundamental idea of at least one embodiment of the invention for the embodiment of the circuit arrangement as a sensor arrangement resides in increasing the pixel frequency by effectively concealing transient behavior in time. The problem occurring in the prior art of too low a read-out speed is thereby solved or at least greatly reduced.

The following signal-transfer strategy is preferably implemented:

1) The sequential signal-transfer process (e.g. read-out) between the functional units (e.g. sensor fields) and the signal unit of the circuit arrangement (e.g. sensor arrangement) cannot be randomly selected but is pre-defined (for example in order of increasing addresses, row by row).

2) The functional units implemented according to the prior art in a single signal line (e.g. column line) are implemented in two or more new sub-signal lines (e.g. sub-column lines). Such sub-signal lines are grouped into signal-line groups.

3) Two or more selection lines (e.g. row lines) are selected simultaneously (e.g. by means of a row decoder) or grouped into a selection-line group. In other words, simultaneously selected selection-lines are grouped into selection-line groups. A selected selection-line (e.g. row line) can be connected exclusively to functional units of a sub-signal line. At a specific time, just one specific functional unit that is assigned both to a selected selection-line group and to a selected signal-line group is read out. Those functional units implemented as sensor elements that are intended to be read out in subsequent cycles and belong both to a selected selection-line group and to an unselected signal-line group, are connected to an associated buffer unit, so that they can already go through transient behavior, preferably over a plurality of signal transfer cycles (e.g. read-out cycles) of functional units (e.g. sensor elements) that are advanced in time.

4) An additional pre-decoder, having buffers connected downstream, is provided in the read-out path.

Sensors belonging to one of the at least two selected selection-lines (row lines) are then either connected to the full data path or to a buffer unit. In other words, those sensors of the selected selection lines that are not already being read out at a certain time are able to settle in this period. The time gained as a result of this leads to an increased pixel frequency and hence frame frequency, and enables faster read-out of the circuit arrangement according to at least one embodiment of the invention.

Preferred developments of the invention follow from the example embodiments.

In at least one embodiment, each selection-line group includes, for example, exactly two selection lines. In addition, in at least one embodiment each signal-line group includes, for example exactly two signal lines.

In at least one embodiment, the circuit arrangement is, for example, configured as a monolithically integrated circuit arrangement. If the circuit arrangement is provided in a monolithically integrated form, in particular formed in a semiconductor substrate (e.g. silicon wafer, silicon chip), a miniaturized implementation of the circuit arrangement is possible. The circuit arrangement can be fabricated using straightforward engineering by the sophisticated processes of silicon microelectronics. In addition, in an integrated implementation of the circuit arrangement, signal paths are short and hence the achievable read-out times are low. Furthermore, an excellent spatial resolution is possible because the functional units can be scaled in the micrometer and sub-micrometer range.

The functional units may be sensor fields and configured such that by way of signal transfer between the currently selected functional unit and the signal unit, a sensor signal can be read out from the selected functional unit implemented as a sensor field.

According to this embodiment, the circuit arrangement is implemented as a sensor arrangement, in which a plurality of sensor fields are preferably arranged in the form of a matrix, with sensor signals being read out from the sensor fields according to the architecture according to at least one embodiment of the invention, which results in a faster read-out capability owing to the elimination of, or reduction in, transient behavior. The temporal resolution of the circuit arrangement implemented as a sensor arrangement can thereby be improved.

In at least one embodiment, the circuit arrangement is preferably implemented as a biosensor arrangement. For example, a plurality of nerve cells can be grown on the surface of the biosensor arrangement, and the electrical impulses from the nerve cells can be detected by biosensors. Alternatively, capture molecules can be immobilized on the sensor fields of the circuit arrangement configured as a biosensor arrangement, which can hybridize with macromolecular biopolymers in an analyte to be examined. Hybridization events can then be detected electrically and/or optically, for example, by way of a sensor signal. Such a biosensor arrangement is particularly advantageous in the area of high-throughput screening.

The functional units may be memory cells and be configured such that via signal transfer between the currently selected functional unit and the signal unit, an information signal can be read out from the selected functional unit configured as a memory cell. In this embodiment, each functional unit is a memory cell, for example a DRAM memory cell or an EPROM memory cell. When reading out the memory contents from the memory cells, transient behavior of the individual memory cells also results in an increase in the read-out time and hence to poorer access times. According to at least one embodiment of the invention, the read-out time is cut and the access time reduced by transient behavior being conducted before the actual read-out process, and the individual memory cells being already in a state ready for read-out, i.e. in, or at least approaching, a steady state, at the start of a read-out cycle.

It should also be mentioned that, in an embodiment of the circuit arrangement as a memory-cell arrangement, the programming of the memory cells, i.e. a signal transfer from a control unit to the memory cells, can also be executed in a faster manner because transient behavior during programming of the memory cells can also be effectively eliminated or reduced by completing the transient behavior prior to the actual storage operation with no impact on the functionality of the rest of the programming.

The functional units may alternatively be playback fields, and may be configured such that by means of signal transfer between the currently selected functional unit and the signal unit, a playback signal is provided from the selected functional unit configured as a playback field.

In this embodiment of the functional units as playback fields, the circuit arrangement is a display device for example, for instance an LCD device or another display device containing pixel elements. The playback of optically perceptible or other information on the circuit arrangement can be performed more quickly by means of the principle according to at least one embodiment of the invention, so that the frequency at which the new images are built up on the display unit is increased.

The circuit arrangement can thus be configured as a display arrangement.

In addition, in at least one embodiment the circuit arrangement may comprise an amplifier unit, which is configured to amplify a signal provided by the selected functional unit of the signal unit. In particular, in an implementation of the circuit arrangement for biosensor applications, the signals obtained are often very small in amplitude and are preferably amplified before being supplied to an external electronic signal processing circuit.

The circuit arrangement can comprise a signal processing sub-circuit for processing a signal to be transferred, where the signal processing sub-circuit may be contained at least partially in a respective buffer unit of a respective signal-line group. According to this embodiment, some of the components (e.g. amplifier, comparator, analog-to-digital converter, reference current source etc.) of an electronic interface circuit may be integrated in each of the buffer units (or some of them). This has the advantage that while a functional unit is settling, it is already connected to the components of the signal processing sub-circuit that are contained in the buffer unit, so that the transient response time of these components can also be advanced in time with respect to the actual signal transfer. This results in a further increase in the read-out rate.

### BRIEF DESCRIPTION OF THE DRAWINGS

Example embodiments of the invention are shown in the figures, and explained in more detail below, in which:

FIG. 1A shows a sensor arrangement according to the prior art,

FIG. 1B shows another sensor arrangement according to the prior art,

FIGS. 2A, 2B show schematic diagrams that are used to explain one aspect of the invention,

FIG. 3A shows a sensor arrangement according to a first example embodiment of the invention in a first operating state,

FIG. 3B shows the sensor arrangement according to the first example embodiment of the invention in a second operating state,

FIG. 4 shows a detailed view of a signal unit of the circuit arrangement according to the invention according to an example embodiment of the invention,

FIGS. 5 and 6 show schematic diagrams that are used to explain how sensor elements are read out according to an example embodiment of the invention,

FIG. 7 shows a schematic view of a circuit arrangement configured as a biosensor arrangement according to a second example embodiment of the invention,

FIG. 8 shows a sensor arrangement according to a third example embodiment of the invention,

FIG. 9 shows a sensor arrangement according to a fourth example embodiment of the invention,

FIG. 10 shows a sensor arrangement according to a fifth example embodiment of the invention.

Identical or similar components in different figures are given the same reference numerals.

The diagrams in the figures are schematic and not to scale.

### DETAILED DESCRIPTION OF THE EXAMPLE EMBODIMENTS

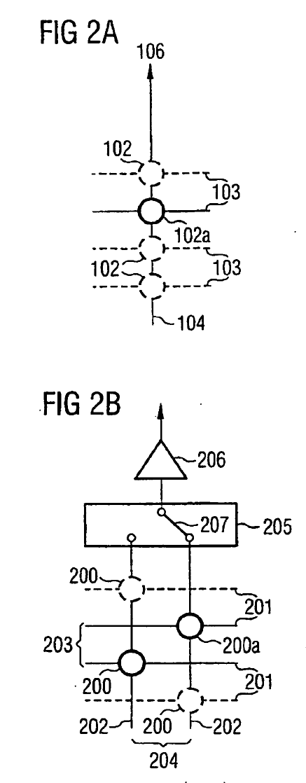

A fundamental idea of the circuit arrangement according to an example embodiment of the invention is described below with reference to FIG. 2A, FIG. 2B.

FIG. 2A shows the principle of reading out sensor elements of a sensor arrangement according to the prior art. It shows a column line 104 having a plurality of sensor elements 102 and a selected sensor element 102a. In addition, it shows row lines 103. The selected sensor element 102a is arranged in an intersection area of a selected row line 103 and the selected column line 104, with a sensor signal from the selected sensor element 102a being supplied to the column decoder 106. If the sensor element 102a is selected, then prior to the actual read-out process, i.e. the signal transfer to the column decoder 106, the selected sensor element 102a must go through transient behavior until it is brought into a state that is sufficiently steady for the read-out. Thus the pixel frequency is low and read-out is slow.

FIG. 2B shows schematically the implementation according to an example embodiment of the invention. It shows a plurality of sensor elements 200, where each sensor element 200 is connected to an associated row line 201 and an associated column line 202.

According to an example embodiment of the invention, a single row line is not now selected, as in FIG. 2A, but two row lines 201 (also called selection lines) of a selected selection-line group 203. In addition, unlike FIG. 2A, a single column line 202 is not selected in FIG. 2B, but two column lines 202 (also called signal lines) assigned to a selected signal-line group 204.

A selected sensor element 200a is due for imminent read-out. This selected sensor element 202a due for imminent read-out belongs both to the selected selection-line group 203 and to the selected signal-line group 204. A switch element 207 of a pre-decoder 205 is switched such that the sensor element 200a selected for imminent read-out is connected to a buffer unit 206. Thus in the operating state shown in FIG. 2B, the selected sensor field 200a has already started transient behavior before the actual read-out process takes place.

If the selected selection-line group 203 and the selected signal-line group 204 is adjusted in such a way, and the electronic interface circuit (not shown in FIG. 2B) is switched in such a way that now the selected and settled sensor element 200a is to release its sensor signal for read-out to the electronic interface circuit, then a read-out time is achieved for this actual read-out that is reduced by the transient response time compared with FIG. 2A. Hence according to FIG. 2B it is possible to read out the sensor elements 200 more quickly because of the increased pixel frequency.

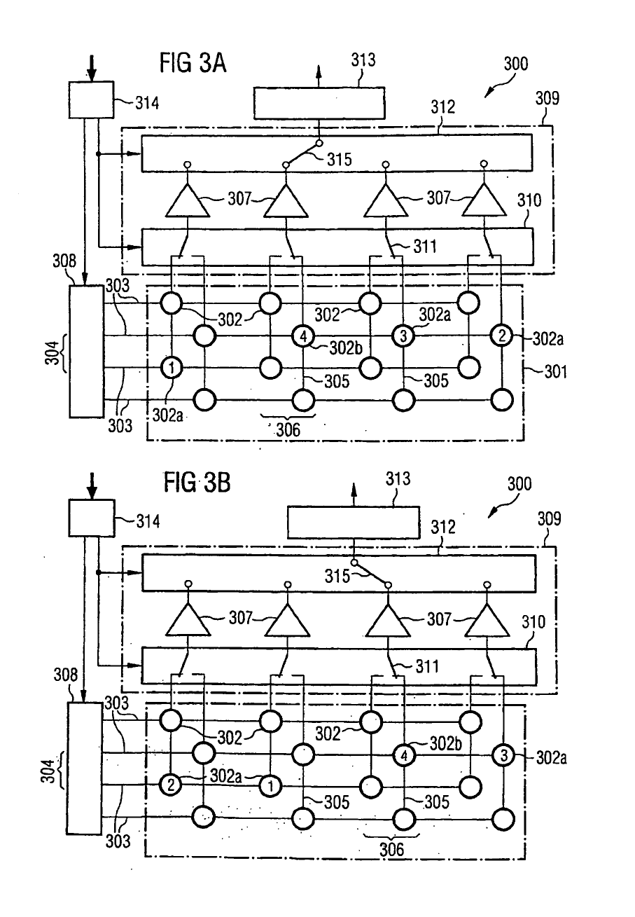

A sensor arrangement 300 according to a first example embodiment of the invention is described below with reference to FIG. 3A, where the sensor arrangement 300 in FIG. 3A is shown in a first operating state.

The sensor arrangement 300 is monolithically integrated in a silicon substrate 301. The sensor arrangement 300 includes a plurality of sensor elements 302 arranged on the silicon substrate 301. In addition, a plurality of selection-line groups are provided, each selection-line group including at least two of a plurality of selection lines 303 (row lines in FIG. 3A), each of which is connected to four of the sensor elements 302. In addition, a plurality of signal-line groups are provided, each signal-line group comprising two signal lines 305 (column lines in FIG. 3A), each of which is connected to two of the sensor elements 302. Each signal-line group is assigned a buffer unit 307.

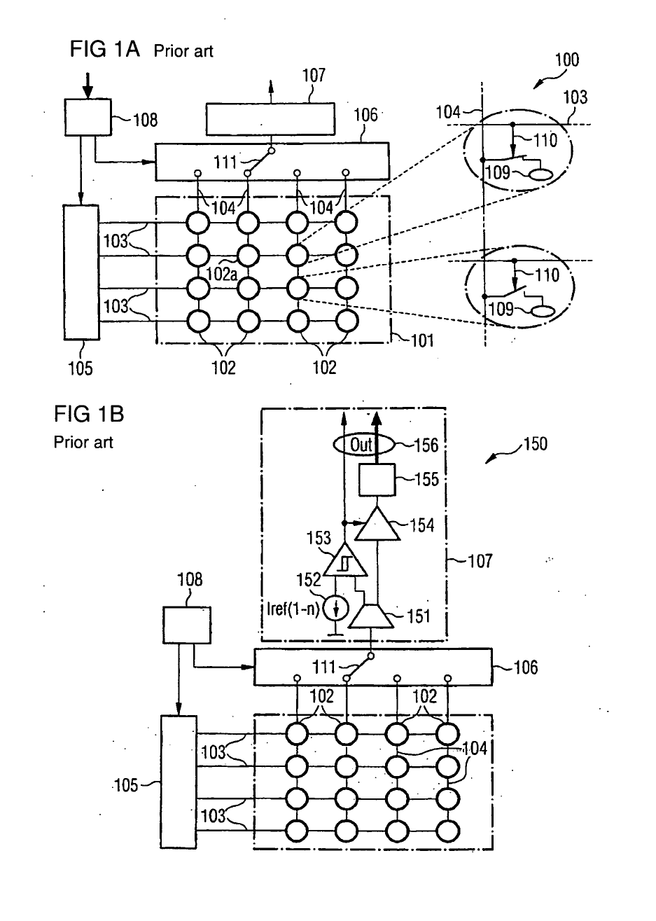

In addition, a selection unit 308 connected to the selection-line groups is shown, which is configured such that by means of a selection signal on the selection lines 303 of a selection-line group 304 to be selected, the sensor elements 302 connected to the selection lines 303 of the selected selection-line group 304 are connected to the associated signal lines 305 (as shown in the magnified diagrams of FIG. 1A). Furthermore, the sensor arrangement 300 contains a signal unit 309 connected to the signal lines 305.

The signal unit 309 is configured in such a way that it selects one, and only one, of the signal-line groups 306 at a time in such a way that, of those sensor elements 302 that belong both to the selected selection-line group 304 and to the selected signal-line group 306, one, and only one, read-selected sensor element 302b at a time is selected for signal transfer between this read-selected sensor element 302b and the signal unit 309. In addition, the signal unit 309 is configured such that, of those sensor elements 302 that belong both to the selected selection-line group 304 and to an unselected signal-line group, it connects one, and only one, settling-selected sensor element 302a at a time to the associated buffer unit 307, thereby allowing this settling-selected sensor element 302a to settle.

The signal unit 309 and the selection unit 308 are provided by an address generator 314 with selection signals for addressing the sensor elements 302.

The signal unit 309 is composed of a pre-decoder 310 having first switch elements 311, the buffer units 307 and the signal decoder 312. The signal decoder 312 is connected on its output side to an electronic interface circuit 313, which is configured to post-amplify a sensor signal read out from a read-selected sensor element 302b.

The way in which the sensor arrangement 300 works is described in more detail below. The sensor arrangement 300 is a 4×4 sensor array, where FIG. 3A shows a first operating state of the sensor arrangement 300. The row lines 303 addressed by the selection unit 308, which may also be called a row decoder, are those assigned to the selected selection-line group 304. The sensor element currently being read out is called the read-selected sensor element 302b. In the operating state shown in FIG. 3A, the sensor elements 302 of the upper selected row line 303 shown in FIG. 3A are read out sequentially.

At the end of each read-out operation, which corresponds to the start of the read-out operation of the sensor signal from the next sensor element in line, the relevant switch elements 311 of the pre-decoder 310 are switched over. As a result of this, a sensor element of the lower selected selection line 303 shown in FIG. 3A is switched to the associated buffer 307 and can start to settle.

In FIG. 3A, those sensor elements that have already started the settling process and are due for read-out in forthcoming read-out cycles, are called settling-selected sensor elements 302a. The numbers in the settling-selected sensor elements 302a in FIG. 3A represent the time, in units of the reciprocal of the pixel frequency, that the respective settling-selected sensor element 302a has already been settling for. The read-selected sensor element 302b connected to the data path 311-307-315-313 here has had the longest time period available for settling (four time units).

The next sensor element due for read-out has accordingly spent the second longest time period in settling, namely three time units. At this point in time, the last settling-selected sensor element 302a to be read out has been settling for the period of one reciprocal of the pixel frequency. Once all the sensor elements of the upper selected selection line 303 have been read out, the sensor elements of the lower selected selection line 303 shown in FIG. 3A of the selected selection-line group 304 are then read out. In addition, the previously upper selected selection line 303 is deselected, and instead an additional new selection line 304 is addressed by the selection unit 308.

A second operating state of the sensor arrangement 300 shown in FIG. 3A is described below with reference to FIG. 3B.

In the second operating state shown in FIG. 3B, the same selection lines 303, and hence the same selection-line group 304, as in FIG. 3A are still selected. Now, however, the pair of signal lines 305, that is assigned to the signal-line group 306 now selected, is shifted one column to the right as shown in FIG. 3B.

According to the operating state of FIG. 3B, the sensor signal from the now read-selected sensor element 302b is now read out, which according to the operating state of FIG. 3A was the settling-selected sensor element 302a, which had already been settling for three time units in the operating state of FIG. 3A. In addition, that sensor element of the sensor elements 302 that in FIG. 3A lies in the same selection line as the settling-selected sensor element 302a labeled with the time unit “1” in FIG. 3A, but shifted one position to the right, is now also selected for settling.

It is apparent that, as shown in the transition from FIG. 3A to FIG. 3B, the settling-selected and read-selected sensor elements 302a, 302b are shifted successively from left to right. After such a shift cycle is complete, a new pair of selection lines 303 is selected to form the selected selection-line group 304.

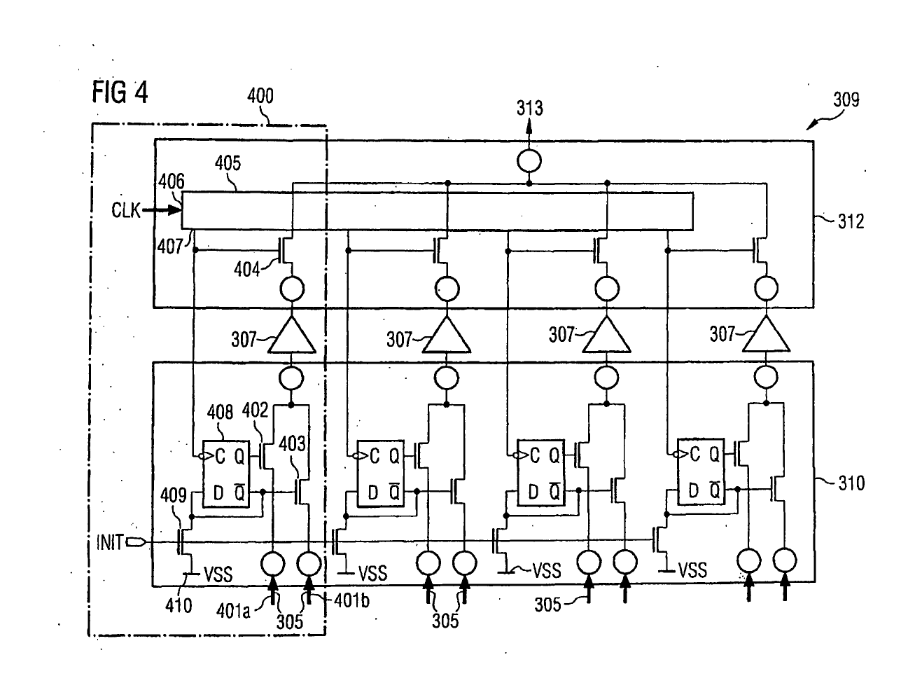

A detailed view of an embodiment of the signal unit 309 in circuitry is described below with reference to FIG. 4.

A function block 400 is provided in the signal unit 309 for each group of two signal lines 305. The function blocks 400 each have essentially the same design, so that the detailed design of the function block 400 is only described for the left-hand pair of signal lines 305 shown in FIG. 4.

The pair of signal lines 305 assigned to the function block 400 comprises a first signal line 401a and a second signal line 401b. The first signal line 401a is connected to a first source/drain region of a first switching transistor 402. The second source/drain region of the first switching transistor 402 is connected to a first source/drain region of a second switching transistor 403, whose second source/drain terminal is connected to the second signal line 401b. The second source/drain region of the first switching transistor 402 and the first source/drain region of the second switching transistor 403 are connected to an input of the buffer 307 assigned to the signal lines 401a, 401b. The output of the buffer 307 is connected to a first source/drain region of a third switching transistor 404. The second source/drain region of the third switching transistor 404 is connected to the electronic interface circuit 313, which is only indicated schematically in FIG. 4.

A common pointer circuit 405 is provided for all the function blocks 400, which is supplied with a clock signal CLK at an input 406. An output 407 of the pointer circuit 405 is connected to the gate region of the third switching transistor 404 and to a first input of a flip-flop 408. A first output of the flip-flop 408 is connected to the gate terminal of the first switching transistor 402. In addition, a second output of the flip-flop 408 is connected to the gate terminal of the second switching transistor 403, to a second input of the flip-flop 408 and to a first source/drain terminal of a fourth switching transistor 409. The second source/drain terminal of the fourth switching transistor 409 is taken to the electrical ground potential 410. The gate terminal of the fourth switching transistor 409 can be controlled by a signal INIT.

The operation of the circuit implementation of the signal unit 309 shown in FIG. 4 is described below.

FIG. 4 shows an example of the implementation of the pre-decoder 310 and the signal decoder 312 of the sensor arrangement 300. The clock signal CLK gates the pointer circuit 405 so that all column addresses (i.e. addresses of the signal lines 305) are selected successively. With every change in a column 305, the falling edge of the pointer-circuit output-signals that gate the switching transistors (active high in the example) is detected in the toggle flip-flop 408 in the pre-decoder 310, and is used to switch the sub-columns 305. The two states of the toggle flip-flop 408 correspond to selecting a sub-column (sub-signal-line) that is linked to a row or selection line having an odd or even address. All the toggle flip-flops 408 of all function blocks 400 can be set into a defined initial state using the control signal INIT, so that the sensor addressing is explicit.

In the explained example, the buffer units 307 are located between pre-decoder 310 and signal decoder 312. Hence it is possible to reduce the limiting effect that the transient response time of the sensor elements 302 has on the pixel frequency.

The transient response times in the interface circuits 313 in the downstream data path are often important as well. In order to increase the pixel frequency further, it is possible in principle to shift the functions of these interface circuits 313, at least partially (for example the signal amplification components) into a stage between pre-decoder 310 and signal decoder 312. Such an implementation involves balancing the increase in read-out speed with the surface area required.

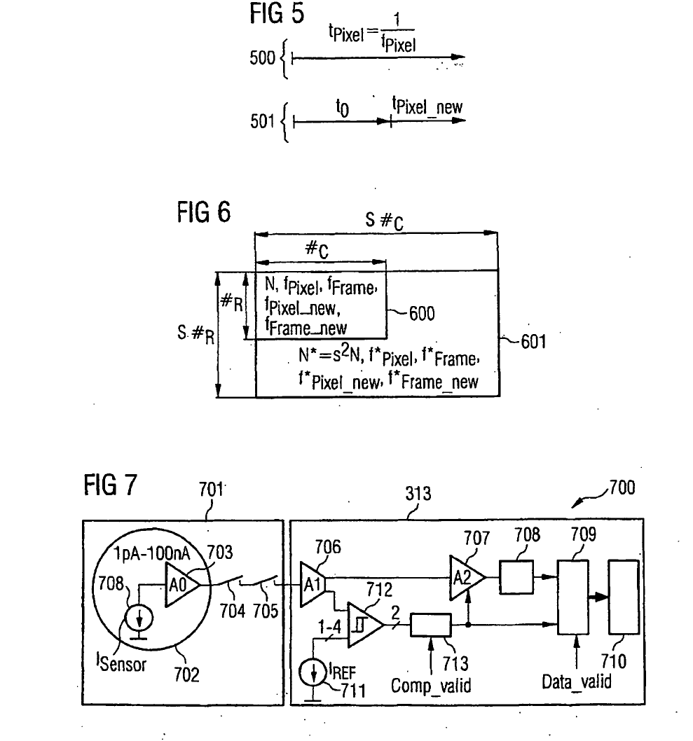

The advantage of the architecture according to an example embodiment of the invention with regard to scaled arrays is explained again below with reference to the schematic diagram of FIG. 5, FIG. 6.

FIG. 5 shows schematically the principle that can be applied to increase the pixel frequency by way of the settling being advanced according to the invention with respect to the actual read-out of a sensor element, i.e. by effectively eliminating the transient response time to.

FIG. 5 shows schematically the achievable read-out time for a conventional implementation 500 of a sensor arrangement compared with the implementation 501 according to an example embodiment of the invention. In the conventional implementation, the read-out time tₚᵢₓₑₗ for reading out one pixel is the reciprocal of the pixel frequency f_{Pixel}, and is made up of the transient response time and the actual read-out time.

In contrast, the time tₚᵢₓₑₗ_{_{—}}_{new} required according to an example embodiment of the invention to read out one pixel is reduced compared with tₚᵢₓₑₗ by the transient response time t₀ that a sensor element connected to a read-out path needs to reach a steady state. Such transient behavior is advanced in time according to an example embodiment of the invention with respect to the actual read-out of a sensor field.

The following relationship applies in FIG. 5:

$${t}_{Pixel} = \frac{1}{{f}_{Pixel}} = {t}_{0} + {t}_{Pixel\_new} \qquad ( 1 )$$

The maximum possible time to that can be saved by way of the strategy according to an example embodiment of the invention when reading out a pixel depends on the number of columns #_{c} in the sensor arrangement:

t₀=(#_{c}−1)t_{Pixel}_{_{—}}_{new} (2)

The pixel frequency f_{Pixel}_{_{—}}_{new} of the strategy according to an example embodiment of the invention is obtained from equations (1) and (2) as:

F_{Pixel}_{_{—}}_{new}=#_{C}f_{Pixel} (3)

Using the nomenclature of FIG. 5, FIG. 6, the frame frequency for the traditional strategy 500, f_{Frame}, and for the strategy 501 according to the invention, f_{Frame}_{_{—}}_{new}, for a circuit arrangement of a certain geometry and of a scaled version of this circuit arrangement is given by:

$$\begin{matrix}{f}_{Frame} = \frac{{f}_{Pixel}}{N} = \frac{{f}_{Pixel}}{{\#}_{C} {\#}_{R}} & ( 4 ) \\ {f}_{Frame\_new} = \frac{{f}_{Pixel}}{{\#}_{R}} = {\#}_{C} {f}_{Frame} & ( 5 ) \\ {f}_{Frame}^{*} = \frac{{f}_{Pixel}}{{s}^{2} N} = \frac{{f}_{Frame}}{{s}^{2}} & ( 6 ) \\ {f}_{Frame\_new}^{*} = \frac{{\#}_{C}}{s} {f}_{Frame} & ( 7 )\end{matrix}$$

where N is the number of positions of a sensor arrangement and #_{R} is the number of rows. In addition, s#_{C} is the number of columns of a scaled sensor arrangement for a scaling factor s, and S#_{R} is the number of rows of the scaled sensor arrangement. Furthermore, N*=Ns² is the number of positions in the scaled sensor arrangement, f*_{Pixel} is the pixel frequency in a conventional scaled sensor arrangement, f*_{Frame} is the frame frequency in a conventional scaled sensor arrangement, f*_{Pixel}_{_{—}}_{new} is the pixel frequency in a scaled sensor arrangement according to the invention, f*_{Frame}_{_{—}}_{new} is the frame frequency in a scaled sensor arrangement according to an example embodiment of the invention.

Table 1 summarizes the calculated values for the conventional strategy 500 and for the strategy 501 according to an example embodiment of the invention. It can be seen from table 1 that using the strategy according to an example embodiment of the invention, a reduction in the array read-out speed when the number of columns and rows are scaled by a factor of s respectively can be compensated by the number of columns #_{C}.

TABLE 1

| | | Number of | | |
|---|---|---|---|---|
| | | sensor | Pixel | Frame |
| Array architecture | | elements | frequency | frequency |
| Conventional | Array | N | F_{Pixel} | f_{Frame} |
| | Scaled | s²N | F_{Pixel} | s⁻²f_{Frame} |
| | array | | | |
| According to | Array | N | #_{c} f_{Pixel} | #_{c} f_{Frame} |
| an example | Scaled | s²N | s #_{c} f_{Pixel} | s⁻¹ #_{c} f_{Frame} |
| embodiment | array | | | |
| of the | | | | |
| invention | | | | |

To summarize, FIG. 5 illustrates the principle of increasing the pixel frequency by concealing the transient response time to on a settling-segment that is advanced in time. FIG. 6 shows properties of the pixel frequency and frame frequency for the conventional sensor array architecture and the sensor array architecture according to an example embodiment of the invention, both having N positions with #_{C} column/signal lines and #_{R} row/selection lines, and for a scaled array having S#_{C} column/signal lines and S#_{R} row/selection lines. The parameters relating to the scaled array are identified by a “*” superscript. The array is labeled 600 and the scaled array is labeled 601 in FIG. 6.

A biosensor arrangement 700 according to a second example embodiment of the invention is described below with reference to FIG. 7. The biosensor arrangement 700 is shown schematically in FIG. 7.

The detection of specific DNA sequences using the biosensor arrangement 700 is based on detecting at the individual sensor positions electrochemically generated electric currents that vary over time. The necessary read-out speed is thus set by the time constants of the electrochemical reactions, or specifically by the physical processes correlated with them (for example diffusion).

Such time constants, which are of the order of 500 ms, are large compared with the reciprocal frequencies typical in electronics. One must also bear in mind, however, that the current signals lie in a dynamic range of approximately 1 pA to 100 nA.

An important mechanism determining the speed in electronic circuits is the fact that a driver current I must transfer the charge in a capacitance C (for example the gate capacitance of a MOS transistor) to give a certain voltage change ΔU. Such charge-transfer operations take place, for example, during the transient phases of circuits. The time At required for this is given by Δt=ΔU*C/I. If one considers by way of example the lower range of possible sensor currents, for I=1 pa, ΔU=1V, C=1 pF, a time of Δt=1000 ms is already obtained. The capacitance value used in the example is if anything rather small considering associated achievable statistical tolerances of switching components in the sub-threshold region.

These estimates show that despite the read-out speed requirements being apparently quite low at first glance, the DNA sensor array is actually a suitable system to implement the circuit arrangement according to an example embodiment of the invention.

In the biosensor arrangement 700, a sensor-field area 701 is provided in which biosensor elements 702 are arranged in the form of a matrix. For simplicity's sake, only one of these biosensor elements 702 is shown in FIG. 7. For a sensor event at the biosensor element 702, a sensor current Iₛₑₙₛₒᵣ occurs that is typically of the order of 1 pA to 100 nA. This is amplified using a sensor-field amplifier element 703. The sensor signal I_{Sensor} can be coupled into the electronic interface circuit 313 given suitable switch settings of a row-selection switch 704 and a column-selection switch 705.

The electronic interface circuit 313 shown in the example embodiment of FIG. 7 includes a first interface amplifier element 706 having an input and two outputs. The sensor signal I_{Sensor} of the biosensor element 702 can be supplied to the input. A first output of the first interface amplifier element 706 is connected to an input of a second interface amplifier element 707. A second output of the first interface amplifier element 706 is connected to a first input of a comparator 712, whose second input is connected to a reference current source 711 for supplying a reference current I_{Ref}. The output of the comparator 712 is connected to an input of a latch 713, the latch 713 being controlled by a control signal Comp_Valid.

The output signal from the latch 713 controls the second interface amplifier element 707 and is supplied to a first input of a transfer element 709. An output of the second interface amplifier element 707 is connected to an input of an analog-to-digital converter 708, whose output is connected to a second input of the transfer element 709. The transfer element 709 is controlled by a control signal Data_Valid. An output of the transfer element 709 is connected to an input of an output register 710.

FIG. 7 shows schematically a data path for the read-out of the electronic DNA sensor array 700. The sensor-field area 701 and the interface circuit 313 are shown separately as blocks. In the sensor-field area 701 the biosensor element 702 is shown by way of example, which can be connected via the row-selection and column-selection switches 704, 705 to the interface circuit 313. The primary sensor signal I_{Sensor} is already pre-amplified in the biosensor element 702 by a first gain factor A₀ using the sensor-field amplifier element 703.

In the interface circuit block 313, the signal is then post-amplified by a gain factor A1 using the first interface amplifier element 706, and duplicated. Since it is not always advantageous or may be difficult to design one analog-to-digital converter 708 for the whole dynamic range defined by the primary sensor signal I_{Sensor}, range adjustment is provided in the example of FIG. 7. This allows the five decades of the primary sensor signal (1 pA to 100 nA) to be mapped onto a suitably narrow dynamic range at the input of the analog-to-digital converter 708. This is done by a copy of the sensor signal following amplification A1 being supplied to a comparator circuit 712 (or a plurality of comparator circuits) where it is compared with a reference current I_{Ref}.

Range-selection bits are obtained as a result of this operation, which undergo configurable post-amplification A2 implemented by the second interface amplifier element 707. The result of the A/D conversion using the analog-to-digital converter 708 is written, together with the range-selection bits, to an output register 710 from where it can be read out. In order to keep necessary transient response times short, the digital data is latched using the control signals Comp_Valid, Data_Valid.

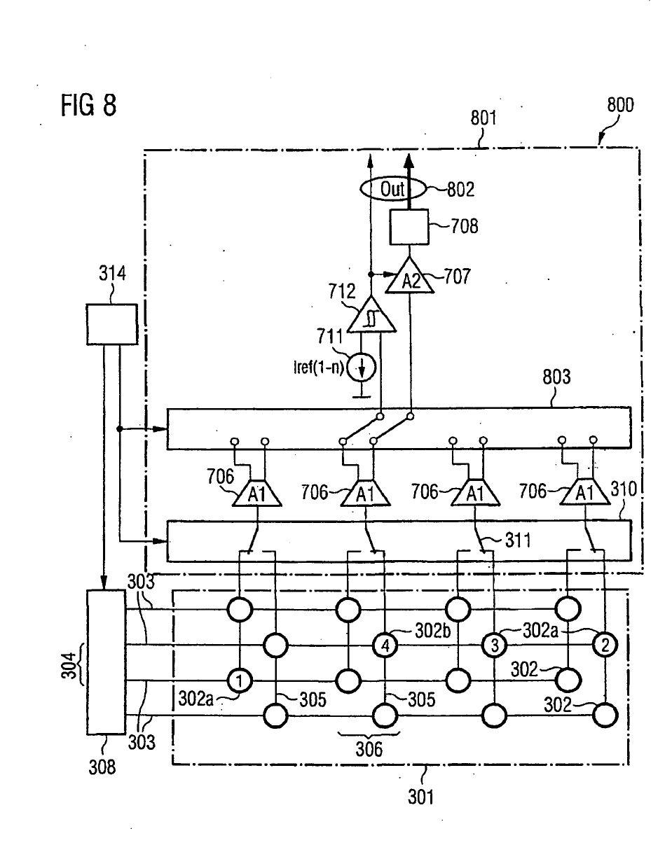

A sensor arrangement 800 according to a third example embodiment of the invention is described below with reference to FIG. 8, in which the interface circuit 801 is implemented in a similar way to that shown in FIG. 7.

In FIG. 8, a column line 305 of a read-selected sensor element 302b is connected to an input of the first interface amplifier element 706, which performs the functions of the buffer unit 307 shown in FIG. 3A. The first interface amplifier element 706 has two outputs. A first output of the first interface amplifier element 706 is connected to an input of the second interface amplifier element 707, whose output is connected to an input of the analog-to-digital converter 708. An output of the analog-to-digital converter 708 is connected to an input of an output block 802.

In addition, a second output of the first interface amplifier element 706 is connected to a first input of the comparator 712, whose second input is connected to the reference current source I_{Ref}(1−n) 711. The output of the comparator 712 is connected to a control input (for providing a control signal) of the second interface amplifier element 707, and is connected to the output block 802.

FIG. 8 shows an implementation corresponding to the circuit architecture according to an example embodiment of the invention, where the post-amplifier stage A1 706 is arranged in a stage between the pre-decoder 310 and the signal decoder 803.

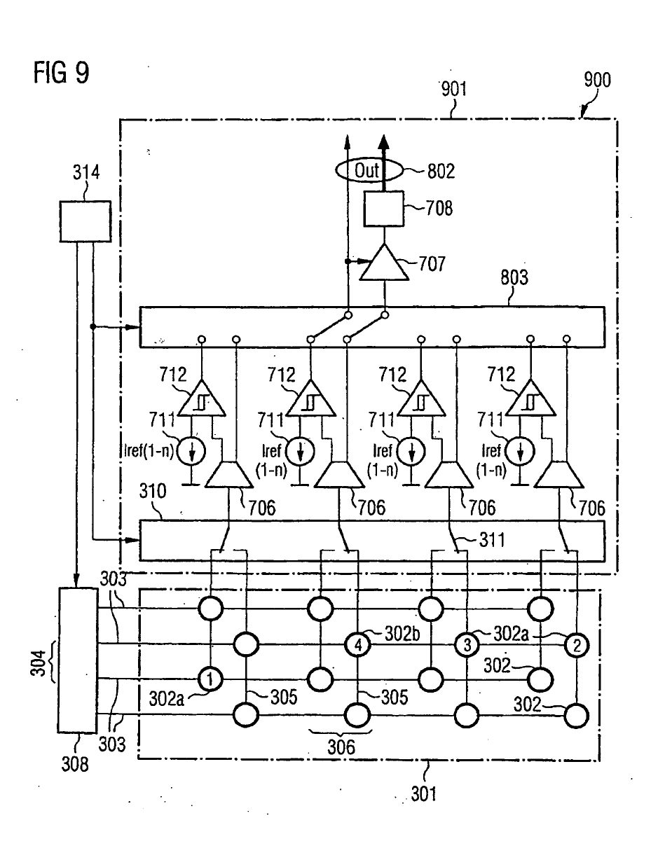

A biosensor arrangement 900 according to a fourth example embodiment of the invention is described below with reference to FIG. 9.

The biosensor arrangement 900 shown in FIG. 9 differs from the biosensor arrangement 800 shown in FIG. 8 in that the electronic interface circuit 901 in FIG. 9 is provided in a modified form compared with FIG. 8. In FIG. 9, reference current sources 711 and comparators 712 are moved into the stage between signal decoder 803 and pre-decoder 310. By moving functions into the stage between components 310 and 803, the read-out speed is further increased by such components being included in the concealed transient behavior.

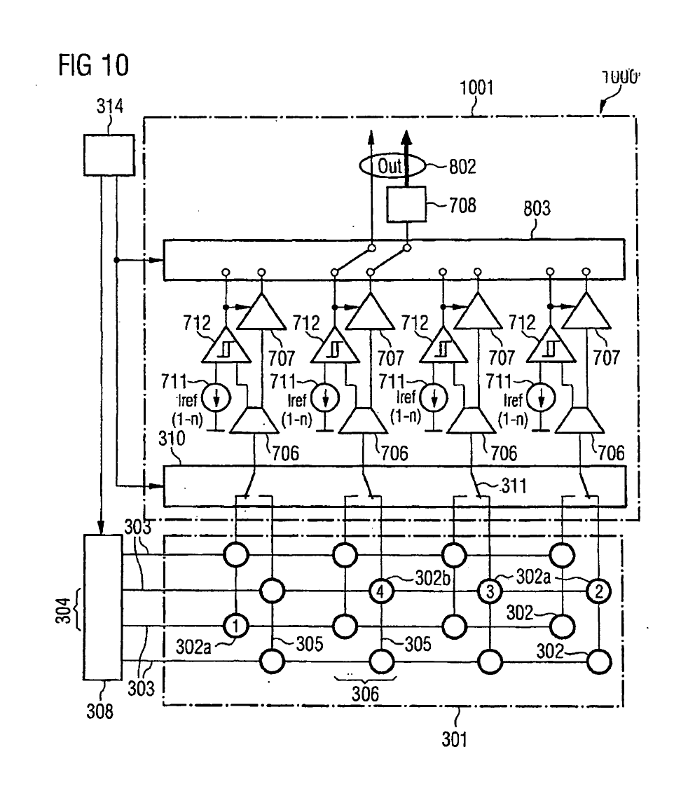

A biosensor arrangement 1000 according to a fifth example embodiment of the invention is described below with reference to FIG. 10.

The biosensor arrangement 1000 shown in FIG. 10 differs from the biosensor arrangement 900 shown in FIG. 9 in that, in addition to the components of the electronic interface circuit 1001 already moved in FIG. 9 into the stage between components 310 and 803, in FIG. 10 the second interface amplifier elements 707 are also connected between components 310 and 803. This further increases the read-out speed.

It should be noted that in a similar way to that shown in FIG. 9 and FIG. 10, other components of the electronic interface circuit can also be moved into the stage between signal decoder 803 and pre-decoder 310.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

The following publications are cited in this document:

[1] Thewes, R et al. “Sensor arrays for fully electronic DNA detection on CMOS”, in Proc. ISSCC 2002, p. 350

[2] DE 102 47 889 A1

[3] EP 1 217 364 A2

[4] WO 01/75462 A1

[5] DE 101 33 363 A1

### LIST OF REFERENCE NUMERALS

100 sensor arrangement
101 substrate
102 sensor element
102a selected sensor element
103 row lines
104 column lines
105 row decoder
106 column decoder
107 electronic interface circuit
108 address generator
109 sensor field
110 switch element
111 selection switch
150 sensor arrangement
151 first amplifier
152 reference current source
153 comparator
154 second amplifier
155 analog-to-digital converter
156 output unit
200 sensor element
200a selected sensor element
201 row lines
202 column lines
203 selected selection-line group
204 selected signal-line group
205 pre-decoder
206 buffer unit
207 switch element
300 sensor arrangement
301 silicon substrate
302 sensor elements
302a settling-selected sensor element
302b read-selected sensor element
303 selection lines
304 selected selection-line group
305 signal lines
306 selected signal-line group
307 buffer unit
308 selection unit
309 signal unit
310 pre-decoder
311 first switch elements
312 signal decoder
313 electronic interface circuit
314 address generator
315 second switch element
400 function block
401a first signal line
401b second signal line
402 first switching transistor
403 second switching transistor
404 third switching transistor
405 pointer circuit
406 input
407 output
408 flip-flop
409 fourth switching transistor
410 ground potential
500 conventional implementation
501 implementation according to an example embodiment of the invention
600 array
601 scaled array
700 biosensor arrangement
701 sensor-field area
702 biosensor element
703 sensor-field amplifier element
704 line-selection switch
705 column-selection switch
706 first interface amplifier element
707 second interface amplifier element
708 analog-to-digital converter
709 transfer element
710 output register
711 reference current source
712 comparator
713 latch
800 biosensor arrangement
801 electronic interface circuit
802 output block
803 signal decoder
900 biosensor arrangement
901 electronic interface circuit
1000 biosensor arrangement
1001 electronic interface circuit

1. A circuit arrangement, comprising:
a substrate;
a plurality of functional units arranged on the substrate;
a plurality of selection-line groups, each selection-line group having at least two selection lines, each being connectable to at least two of the functional units;
a plurality of signal-line groups, each signal-line group having at least two signal lines, each being connectable to at least two of the functional units;
a buffer unit for each signal-line group;
a selection unit connected to the selection-line groups, configured such that by applying a selection signal to the selection lines of a selection-line group to be selected, the functional units connected to the selection lines of the selected selection-line group are connected to the associated signal lines;
a signal unit connected to the signal lines, configured such that
it selects one, and only one, of the signal-line groups at a time in such a way that, of those functional units that belong both to the selected selection-line group and to the selected signal-line group, one, and only one, functional unit is selected at a time for signal transfer between this functional unit and the signal unit;
of those functional units that belong both to the selected selection-line group and to an unselected signal-line group, it connects one, and only one, functional unit at a time to the
associated buffer unit, thereby allowing this functional unit to settle.

2. The circuit arrangement as claimed in claim 1,
wherein each selection-line group comprises exactly two selection lines.

3. The circuit arrangement as claimed in claim 1, wherein
each signal-line group comprises exactly two signal lines.

4. The circuit arrangement as claimed in claim 1, wherein
the circuit arrangement is configured as a monolithically integrated circuit arrangement.

5. The circuit arrangement as claimed in claim 1, wherein
the functional units are sensor fields and configured such that by way of signal transfer between the currently selected functional unit and the signal unit, a sensor signal is readable out from the selected functional unit implemented as a sensor field.

6. The circuit arrangement as claimed in claim 1, wherein the circuit arrangement is configured as a biosensor arrangement.

7. The circuit arrangement as claimed in claim 1, wherein
the functional units are memory cells and are configured such that by way of signal transfer between the currently selected functional unit and the signal unit, an information signal is readable out from the selected functional unit configured as a memory cell.

8. The circuit arrangement as claimed in claim 1, wherein the functional units are playback fields and are configured such that, by way of signal transfer between the currently selected functional unit and the signal unit, a playback signal is providable from the selected functional unit configured as a playback field.

9. The circuit arrangement as claimed in claim 1, wherein the circuit arrangement is configured as a display arrangement.

10. The circuit arrangement as claimed in claim 1, further comprising an amplifier unit, useable to amplify a signal provided by the selected functional unit of the signal unit.

11. The circuit arrangement as claimed in claim 1, further comprising
a signal processing sub-circuit for processing a signal to be transferred, where said signal processing sub-circuit is contained at least partially in a respective buffer unit of a respective signal-line group.

12. The circuit arrangement as claimed in claim 2, wherein each signal-line group comprises exactly two signal lines.

13. The circuit arrangement as claimed in claim 2, wherein the circuit arrangement is configured as a monolithically integrated circuit arrangement.

14. The circuit arrangement as claimed in claim 3, wherein the circuit arrangement is configured as a monolithically integrated circuit arrangement.

15. The circuit arrangement as claimed in claim 2, wherein the circuit arrangement is configured as a display arrangement.

16. The circuit arrangement as claimed in claim 8, wherein the circuit arrangement is configured as a display arrangement.

17. The circuit arrangement as claimed in claim 2, wherein the functional units are sensor fields and configured such that by way of signal transfer between the currently selected functional unit and the signal unit, a sensor signal is readable out from the selected functional unit implemented as a sensor field.

18. The circuit arrangement as claimed in claim 3, wherein the functional units are sensor fields and configured such that by way of signal transfer between the currently selected functional unit and the signal unit, a sensor signal is readable out from the selected functional unit implemented as a sensor field.

19. The circuit arrangement as claimed in claim 4, wherein the functional units are sensor fields and configured such that by way of signal transfer between the currently selected functional unit and the signal unit, a sensor signal is readable out from the selected functional unit implemented as a sensor field.
